(19) United States
(12) Patent Application Publication
(10) Pub. No.: US 2005/0128046 A1
(43) Pub. Date: Jun. 16, 2005

(54) Over-current protection device

(76) Inventors: Zack Lin, Sindian City (TW); Ching Han Yu, Fonglin Township (TW)

Correspondence Address: Harold V. Stotland;Seyfarth Shaw, 42nd Floor, 55 East Monroe Street, Chicago, IL, 60603-5803, US

(21) Appl. No.: 11/000,788

(22) Filed: Dec. 1, 2004

(30) Foreign Application Priority Data
Dec. 10, 2003 (TW) 092134922

(51) Int. Cl. H01C 7/02

(52) U.S. Cl. 338/25; 338/315

(57) ABSTRACT

An over-current protection device includes a current-sensitive element, two insulating layers and two electrode layers. The current-sensitive element comprises two electrode foils and a current-sensitive layer laminated between the two electrode foils, where the current-sensitive layer has the behavior of positive temperature coefficient. The two insulating layers are stacked on the upper and lower surfaces of the current-sensitive element, respectively, and the glass switching temperature thereof is between 90-120° C. or the heat dissipation rate is between 1-7W/° C.-m. The two electrode layers are connected to the two ends of the current-sensitive element, respectively.

### BACKGROUND OF THE INVENTION

(A) Field of the Invention

The present invention is related to an over-current protection device, and more specifically to an over-current protection device capable of increasing operation current.

(B) Description of the Related Art

The resistance of a positive temperature coefficient (PTC) conductive material is sensitive to temperature variation, and can be kept extremely low at normal operation due to its low sensitivity to temperature variation so that the circuit can operate normally. However, if an over-current or an over-temperature event occurs, the resistance will immediately increase to a high resistance state (e.g., above 10⁴ ohm.) Therefore, the over-current will be reversely eliminated and the objective of protecting the circuit device can be achieved. Consequently, PTC devices have been commonly integrated into various circuitries so as to prevent the damage caused by over-current.

A traditional over-current protection device comprises a current-sensitive element and two pre-preg (P/P) layers. The P/P layers are stacked on the surfaces of the current-sensitive element by hot press, and in consequence they function as an exterior protective material of the current-sensitive element to prevent moisture immersion and scratch. Moreover, the P/P layers function as insulation layers also.

The glass switching temperature (Tg) of P/P is commonly between 130 and 140° C., and the glass switching temperature of the so-called high Tg P/P is between 170 and 180° C. The curing temperature of the P/P layers needs to be taken into account for hot-pressing the P/P layers and the current-sensitive element, and the hot-press temperature has to be larger than the glass switching temperature of the P/P layer by 30 to 50° C. However, such high temperature process may cause the expansion of the PTC material within the current-sensitive element, or even wrinkles on the surface of the P/P layer. Under the circumstances, the above events will affect the final dimensions of the over-current protection device. Further, after the over-current protection device is hot-pressed, the resistance of the over-current protection device becomes larger than 1.2 times that before being hot-pressed, inducing the applications for the over-current protection device to be tremendously limited.

Moreover, for the decrease in size of the over-current device, the heat dissipation of the device becomes an important design factor. Traditionally, the heat dissipation rate of a P/P layer is between 0.3 and 0.5W/° C.-m. However, it cannot dissipate heat efficiently, and therefore the life-time and reliability of the over-current protection device are decreased. Accordingly, if the heat dissipation rate of the P/P layer can be increased, the over-current protection device will have more stable performance, and can be used in more applications.

### SUMMARY OF THE INVENTION

The objective of the present invention is to provide an over-current protection device for decreasing the resistance trip ratio of the over-current protection device through hot-press, and increasing the heat dissipation rate so as to increase the operation current, so that the device can be in wide use.

To achieve the above-mentioned objective, an over-current protection device is disclosed. The over-current protection device comprises a current-sensitive element, two insulating layers and two electrode layers. The current-sensitive element comprises two electrode foils and a current-sensitive layer laminated between the two electrode foils, where the current-sensitive element is composed of PTC material. The two insulating layers are stacked on the upper and lower surfaces of the current-sensitive element, respectively, and the glass switching temperature thereof is between 90-120° C. or the heat dissipation rate is between 1-7W/° C.-m. The two electrode layers are connected to the two ends of the current-sensitive element, respectively.

As usual, the two electrode layers are composed of copper, aluminum or aluminum-copper alloy, but there may be a potential oxidation issue due to the nature of the materials. The over-current protection device can further comprise two soldering electrode layers capping the two electrode layers, where the two soldering electrode layers are composed of tin or tin-lead alloy that is capable of anti-oxidation. Consequently, the two electrode layers are not directly in contact with atmosphere, so that the oxidation of the two electrode layers can be avoided.

### BRIEF DESCRIPTION OF THE DRAWINGS

FIG. 1 illustrates the over-current protection device of the first embodiment in accordance with the present invention;

FIG. 2 is the cross-sectional view along the line 1-1 in FIG. 1; and

FIG. 3 illustrates the over-current protection device of the second embodiment in accordance with the present invention.

### DETAILED DESCRIPTION OF THE INVENTION

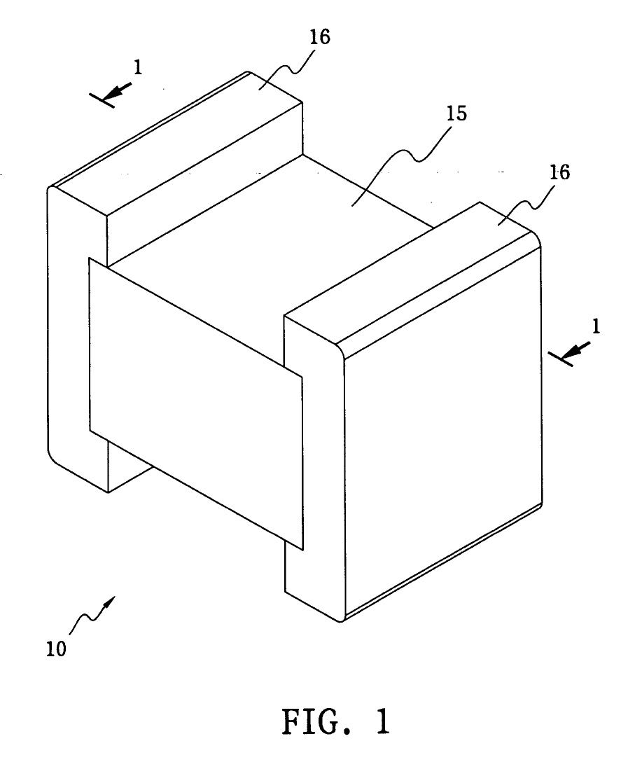

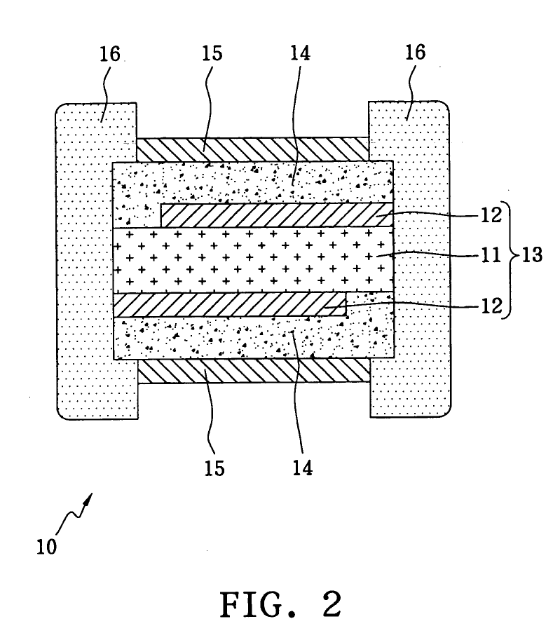

FIG. 1 illustrates the over-current protection device 10 of the first embodiment, and FIG. 2 is the cross-sectional view of the line 1-1 in FIG. 1. The over-current protection device 10 comprises a current-sensitive element 13, two insulating layers 14, two solder-mask (S/M) layers 15 and two electrode layers 16. The current-sensitive element 13 comprises a current-sensitive layer 11 and two electrode foils 12, where the current-sensitive layer 11 is sandwiched between the two electrode foils 12. The current-sensitive layer 11 is composed of polymeric PTC material. The insulating layer 14 can be composed of P/P, resin or epoxy, and the glass switching temperature is between 90 and 120° C. The two electrode layers 16 are disposed at the two ends of the current-sensitive element 13, two insulating layers 14 and two S/M layers 15, respectively.

In comparison with the insulating layers of a known over-current protection device, the insulating layers 14 of the over-current protection device 10 have lower glass switching temperature. Therefore, the dimensions of the over-current protection device 10 vary slightly through hot-press, and the resistance trip ratio through hot-press can be decreased.

Referring to Table 1, the over-current protection device 10, including the insulating layer of lower glass switching temperature, has lower resistance, i.e., it can provide larger operation current.

TABLE 1

| | Resistance Trip Ratio Through Hot Press | |
|---|---|---|
| | The present invention | Known |
| Device | (90° C. ≦ Tg ≦ 120° C.) | (130° C. ≦ Tg ≦ 140° C.) |
| 0603 | 1.07 | 1.31 |
| 0805 | 1.01 | 1.30 |
| 1206 | 1.00 | 1.22 |

Power dissipation (Pd) of the over-current protection device can be expressed by the equation Pd=I²R, wherein I is current, and R is resistance. According to the above equation, the higher the power dissipation is, the higher the current is. From physical point of view, better heat dissipation rate indicates that the heat caused by current can be dissipated fast, i.e., better power dissipation efficiency. Accordingly, the device before being tripped can withstand more current. In other words, an over-current protection device of higher heat dissipation rate can be applied to the circumstances under larger operation current.

The test result of the over-current protection device 10 including the insulating layer 14 made of P/P, resin or epoxy with heat dissipation rate between 1-7W/° C.-m is shown in Table 2. In view of Table 2, the over-current protection device set forth in the present invention, i.e., the one having an insulating layer of higher heat dissipation rate, has higher operation current and power dissipation in comparison with a known one.

TABLE 2

| | Over-Current Protection Device | |
|---|---|---|
| | The present invention | Known |
| Device 0805 | (1-7 W/° C.-m) | (0.3-0.5 W/° C.-m) |
| Resistance (ohm) | 0.248 | 0.245 |
| Operation Current (A) | 1.10 | 0.95 |
| Power Dissipation (W) | 0.66 | 0.54 |

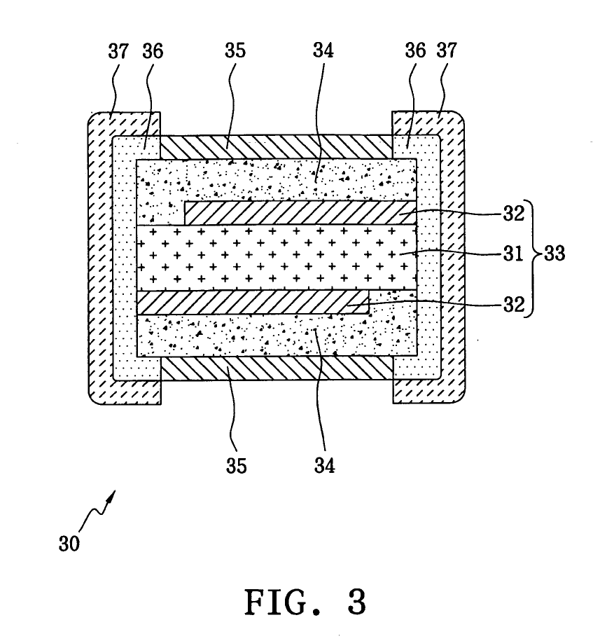

FIG. 3 illustrates an over-current protection device 30 of the second embodiment in accordance with the present invention. The over-current protection device 30 comprises a current-sensitive element 33, two insulating layers 34, two S/M layers 35, two electrode layers 36 and two soldering electrode layers 37. The current-sensitive element 33 is formed by laminating a current-sensitive layer 31 between two electrode foils 32, wherein the current-sensitive layer 31 is made of polymeric PTC material. The insulating layer 34 can be made of P/P, resin or epoxy whose glass switching temperature is between 90-120° C. or heat dissipation rate is between 1-7W/° C.-m. The two electrode layers 36 are disposed at the two ends of the current-sensitive element 33, two insulating layer 34 and two S/M layers 35, respectively. The two soldering electrode layers 37 cap the electrode layers 36 for being connected with leads.

In comparison with the over-current protection device 10, the over-current protection device 30 further comprises the two soldering electrode layers 37 capping the two electrode layers 36. For increasing electrical conduction, the electrode layers 36 are commonly composed of copper, aluminum and aluminum-copper alloy. If the electrode layers 36 are soldered to leads, the electrode layers 36 exposed to atmosphere will be easily oxidized. The soldering electrode layers 37 are made of tin or tin-lead alloy which has the anti-oxidation nature, so that the electrode layers 36 can be avoided to directly contact atmosphere by capping the soldering electrode layers 37 thereon.

The above-described embodiments of the present invention are intended to be illustrative only. Numerous alternative embodiments may be devised by those skilled in the art without departing from the scope of the following claims.

1. An over-current protection device, comprising:
a current-sensitive element, comprising:
two electrode foils; and
a current-sensitive layer having positive temperature coefficient and being sandwiched between the two electrode foils;
two insulating layers stacked on the upper and lower surfaces of the current-sensitive element, respectively, wherein the two insulating layers have at least one of the following features:
(a) glass switching temperature between 90 and 120° C.; and
(b) heat dissipation rate between 1-7W/° C.-m; and
two electrode layers connected to two ends of the current-sensitive element, respectively.

2. The over-current protection device in accordance with claim 1, wherein the material of the insulating layers is selected from the group substantially consisting of pre-preg, resin and epoxy.

3. The over-current protection device in accordance with claim 1, wherein the current-sensitive layer is made of polymeric positive temperature coefficient material.

4. The over-current protection device in accordance with claim 1, further comprising two solder-mask layers disposed on surfaces of the two insulating layers, respectively.

5. The over-current protection device in accordance with claim 1, wherein the material of the two electrode layers is selected from the group substantially consisting of copper, aluminum and copper-aluminum alloy.

6. The over-current protection device in accordance with claim 1, further comprising two soldering electrode layers capping the two electrode layers, so as to prevent the two electrode layers from oxidation.

7. The over-current protection device in accordance with claim 6, wherein the material of the soldering electrode layers is selected from the group substantially consisting of tin, lead and tin-lead alloy.
